(19) United States
(12) Patent Application Publication
(10) Pub. No.: US 2025/0097615 A1
(43) Pub. Date: Mar. 20, 2025

(54) Electronic Device

(71) Applicant: VIVO MOBILE COMMUNICATION CO.,LTD., Dongguan (CN)

(72) Inventors: Jian Ding, Dongguan (CN); Zhihao Niu, Dongguan (CN); Le Zhang, Dongguan (CN); Dingwen Deng, Dongguan (CN); Yeqing He, Dongguan (CN); Botian Zhang, Dongguan (CN)

(21) Appl. No.: 18/959,131

(22) Filed: Nov. 25, 2024

Related U.S. Application Data
(63) Continuation of application No. PCT/CN2023/095999, filed on May 24, 2023.

(30) Foreign Application Priority Data
May 26, 2022 (CN) 202210589390.5

(51) Int. Cl. H04R 1/02

(52) U.S. Cl. CPC H04R 1/02

(57) ABSTRACT

This application discloses an electronic device, which includes a first bracket and a second bracket arranged opposite each other, as well as a circuit board, a loudspeaker unit, and an enclosing assembly that are located between the first bracket and the second bracket. The circuit board has a first notch, and the loudspeaker unit is arranged in the first notch. The enclosing assembly is arranged around the first notch, and the enclosing assembly is hermetically connected to the first bracket, the second bracket, and the circuit board. The first bracket, the second bracket, the circuit board, and the enclosing assembly enclose an acoustic chamber of the loudspeaker unit.

### CROSS-REFERENCE TO RELATED APPLICATIONS

This application is a Bypass Continuation Application of International Patent Application No. PCT/CN2023/095999, filed May 24, 2023, and claims priority to Chinese Patent Application No. 202210589390.5, filed May 26, 2022, the disclosures of which are hereby incorporated by reference in their entireties.

### BACKGROUND OF THE INVENTION

### Field of the Invention

This application pertains to the field of battery technologies, and relates to an electronic device.

### Description of Related Art

Currently, a loudspeaker unit of an electronic device, for example, an acoustic chamber of an upper loudspeaker unit, can be enclosed by a circuit board such as a printed circuit board (PCB) and two circuit board cover plates arranged on two sides of the circuit board.

Specifically, a region of the circuit board facing the loudspeaker unit is provided with a through hole for the loudspeaker unit to pass through, and each of the two circuit board cover plates and the circuit board are sealed through pressing by using sealing foam, so that the circuit board and the two circuit board cover plates arranged on the two sides of the circuit board enclose the acoustic chamber of the loudspeaker unit.

As such, since each of the two circuit board cover plates and the PCB are sealed through pressing by using the sealing foam, a sound outlet channel of the loudspeaker unit is relatively long, leading to poor electroacoustic performance of the loudspeaker unit in the electronic device.

### SUMMARY OF THE INVENTION

An embodiment of this application provides an electronic device including: a first bracket and a second bracket arranged opposite each other, as well as a circuit board, a loudspeaker unit, and an enclosing assembly that are located between the first bracket and the second bracket. The circuit board has a first notch, and the loudspeaker unit is arranged in the first notch. The enclosing assembly is arranged around the first notch, and the enclosing assembly is hermetically connected to the first bracket, the second bracket, and the circuit board. The first bracket, the second bracket, the circuit board, and the enclosing assembly enclose an acoustic chamber of the loudspeaker unit.

### BRIEF DESCRIPTION OF THE DRAWINGS

FIG. 1 is a first schematic structural diagram of an electronic device according to an embodiment of this application;

FIG. 2 is a schematic structural diagram of a sound outlet hole in an electronic device according to an embodiment of this application;

FIG. 3A is a first schematic diagram of comparison between a circuit board in an electronic device according to an embodiment of this application and a circuit board in the prior art;

FIG. 3B is a second schematic diagram of comparison between a circuit board in an electronic device according to an embodiment of this application and a circuit board in the prior art;

FIG. 4 is a second schematic structural diagram of an electronic device according to an embodiment of this application;

FIG. 5 is a third schematic structural diagram of an electronic device according to an embodiment of this application;

FIG. 6 is a fourth schematic structural diagram of an electronic device according to an embodiment of this application;

FIG. 7 is a fifth schematic structural diagram of an electronic device according to an embodiment of this application;

FIG. 8 is a sixth schematic structural diagram of an electronic device according to an embodiment of this application;

FIG. 9 is a seventh schematic structural diagram of an electronic device according to an embodiment of this application;

FIG. 10 is an eighth schematic structural diagram of an electronic device according to an embodiment of this application;

FIG. 11 is a ninth schematic structural diagram of an electronic device according to an embodiment of this application;

FIG. 12 is a tenth schematic structural diagram of an electronic device according to an embodiment of this application; and

FIG. 13 is a schematic diagram of a first sealing structure in an electronic device according to an embodiment of this application.

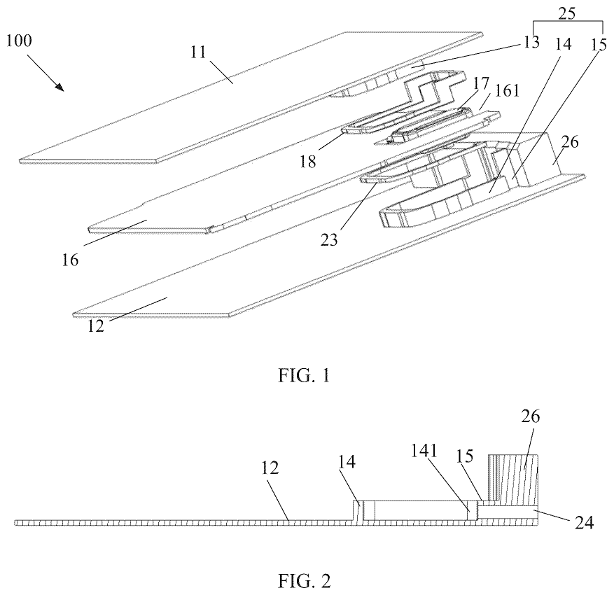

Reference signs in FIG. 1 to FIG. 13 are as follows:
10. electronic device; 11. first bracket; 12. second bracket; 13. first enclosing plate; 14. second enclosing plate; 141. side opening of second enclosing plate; 15. transition leg; 151. extension portion; 152. upright plate; 16. circuit board; 161. first notch; 17. loudspeaker unit; 18. first sealing structure; 19. first gap; 20. second sealing structure; 201. sealing rib; 22. third sealing structure; 23. target sealing ring; 24. sound outlet hole; 25. enclosing assembly; and 26. side wall of frame.

### DESCRIPTION OF THE INVENTION

The following clearly describes the technical solutions in the embodiments of this application with reference to the accompanying drawings in the embodiments of this application. Apparently, the described embodiments are merely some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to indicate a specific order or sequence. It should be understood that data used in this way is used interchangeably in appropriate circumstances so that the embodiments of this application can be implemented in other orders than the order illustrated or described herein. In addition, “first”, “second”, and the like are usually used to distinguish objects of a same type, and do not restrict a quantity of objects. For example, there may be one or a plurality of first objects. In addition, “and/or” in the specification and claims represents at least one of connected objects, and the character “/” generally indicates that the contextually associated objects have an “or” relationship.

The following describes an electronic device provided in the embodiments of this application by using specific embodiments and application scenarios thereof with reference to the accompanying drawings.

An embodiment of this application provides an electronic device. FIG. 1 is a possible schematic structural diagram of an electronic device according to this embodiment of this application. As shown in FIG. 1, the electronic device 100 provided in this embodiment of this application includes: a first bracket 11 and a second bracket 12 arranged opposite each other, as well as a circuit board 16, a loudspeaker unit 17, and an enclosing assembly 25 that are located between the first bracket 11 and the second bracket 12. The circuit board 16 has a first notch 161, and the loudspeaker unit 17 is arranged in the first notch 161. The enclosing assembly 25 is arranged around the first notch 161, and the enclosing assembly 25 is hermetically connected to the first bracket 11, the second bracket 12, and the circuit board 16. The first bracket 11, the second bracket 12, the circuit board 16, and the enclosing assembly enclose an acoustic chamber of the loudspeaker unit 17.

Optionally, as shown in FIG. 1, the circuit board 16 may be a main circuit board in the electronic device, and the circuit board may be a printed circuit board or other possible circuit boards, which is not limited herein.

In this embodiment of this application, the enclosing assembly forms a side wall of the acoustic chamber, and the first bracket and the second bracket form a top wall and a bottom wall of the acoustic chamber.

The first bracket, the enclosing assembly, and the circuit board enclose a first accommodating chamber, and the second bracket, the enclosing assembly, and the circuit board enclose a second accommodating chamber. The first notch on the circuit board allows the first accommodating chamber to communicate with the second accommodating chamber.

It should be noted that an axis of a sound outlet hole of the loudspeaker unit is parallel to the circuit board.

In this embodiment of this application, compared with a solution of the related art in which the circuit board is provided with a through hole, the solution of this embodiment of this application in which the circuit board is provided with a first notch allows the loudspeaker unit to be arranged close to an edge of the circuit board because a narrow pressing edge on the circuit board is removed. This can shorten the length of the sound outlet hole of the loudspeaker unit, which is also known as the length of a sound outlet channel.

Optionally, the loudspeaker unit may be arranged on the first bracket, or the loudspeaker unit may be arranged on the second bracket.

It should be noted that for the loudspeaker unit, in a case that the loudspeaker unit has no change, a volume of the acoustic chamber of the loudspeaker unit and a length of the sound outlet channel are the main factors affecting an external sound output effect of the loudspeaker unit. A larger volume of the acoustic chamber indicates a shorter sound outlet channel and better electroacoustic performance.

Optionally, as shown in FIG. 1, the enclosing assembly 25 may include: a first enclosing plate 13, a second enclosing plate 14, and a transition leg 15.

The first enclosing plate 13 is arranged between the first bracket 11 and the circuit board 16, and two ends of the first enclosing plate 13 are hermetically connected to the first bracket 11 and the circuit board 16. The second enclosing plate 14 is arranged between the second bracket 12 and the circuit board 16, and two ends of the second enclosing plate 14 are hermetically connected to the second bracket 12 and the circuit board 16. The first enclosing plate 13 and the second enclosing plate 14 each have a side opening facing a same direction as the first notch 161. A side portion of the transition leg 15 is hermetically connected to the side opening of the first enclosing plate 13, the side opening of the second enclosing plate 14, and the circuit board 16, and two ends of the transition leg 15 are hermetically connected to the first bracket 11 and the second bracket 12.

The first notch 161 is located at inner sides of projection regions of the first enclosing plate 13 and the second enclosing plate 14 on the circuit board 16.

It can be understood that in this embodiment of this application, the projection regions of the first enclosing plate and the second enclosing plate on the circuit board may be in any possible shape such as a “U” shape or a major arc shape (that is, an arc with a radian greater than) 180°.

In a practical implementation, the shapes of the projection regions of the first enclosing plate and the second enclosing plate on the circuit board may be the same as the shape of the first notch.

In this embodiment of this application, “the first notch is located at inner sides of projection regions of the first enclosing plate and the second enclosing plate on the circuit board” can ensure that the first notch can achieve communication between the first accommodating chamber and the second accommodating chamber.

In this embodiment of this application, “the transition leg is hermetically connected to the side opening of the first enclosing plate and the side opening of the second enclosing plate” can be understood as that the side portion of the transition leg is hermetically connected to an outer wall at the side opening of the first enclosing plate and an outer wall at the side opening of the second enclosing plate.

For example, as shown in FIG. 2, the transition leg 15 is integrally formed with the outer wall at the side opening 141 of the second enclosing plate 14.

Optionally, as shown in FIG. 2, the second enclosing plate 14, the transition leg 15, and the second bracket 12 may be integrally formed.

In this embodiment of this application, the transition leg extends beyond the second enclosing plate. To be specific, the height of the transition leg is greater than the height of the second enclosing plate.

Optionally, the first enclosing plate and the first bracket may be integrally formed.

Optionally, the height of the transition leg may be equal to a sum of the height of the first enclosing plate and the height of the second enclosing plate.

It should be noted that in this embodiment of this application, the height of a component (for example, the transition leg) in the electronic device refers to a maximum dimension of the component in a direction of a connection line (for example, a perpendicular line) of the first bracket and the circuit board.

In this embodiment of this application, the height of the loudspeaker unit is greater than the height of the first enclosing plate and the height of the second enclosing plate.

In this embodiment of this application, the first enclosing plate and the second enclosing plate each have a side opening facing a same direction as the first notch, ensuring that the side portion of the transition leg can be hermetically connected to the circuit board (a side wall of the circuit board).

In addition, the first enclosing plate and the second enclosing plate each have a side opening, and the side opening of the first enclosing plate and the side opening of the second enclosing plate face a same direction as the first notch and both face the transition leg, so that it is unnecessary to reserve a narrow pressing edge in a region of the circuit board close to the transition leg, providing assurance for providing the first notch on the circuit board.

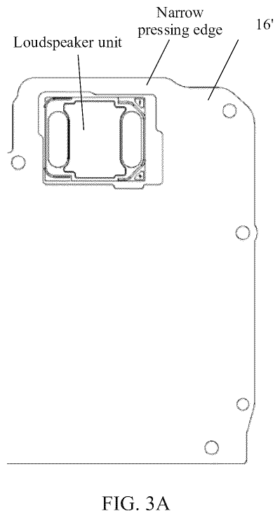

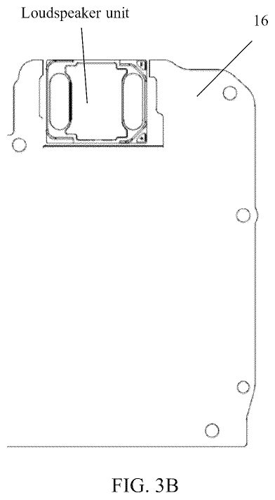

It can be understood that in this embodiment of this application, as shown in FIG. 3A and FIG. 3B, FIG. 3A is a schematic layout diagram of a loudspeaker unit and a circuit board in the related art. As shown in FIG. 3A, the circuit board 16′ in the related art is provided with a narrow pressing edge, so that a distance between the loudspeaker unit and the edge of the circuit board is at least greater than the width of the narrow pressing edge. FIG. 3B is a schematic layout diagram of the loudspeaker unit and the circuit board in this embodiment of this application. It can be seen that: 1. The loudspeaker unit in the electronic device provided in this embodiment of this application can be arranged closer to the edge of the circuit board 16, thereby shortening the length of the sound outlet channel of the loudspeaker unit. 2. In the related art, a layout space close to the narrow pressing edge of the circuit board has low utilization due to its small size, leading to a demand for an increased effective layout area on the circuit board in the related art in a case that the layout requirements remain unchanged, thus facilitating a thin and light design of the entire electronic device. In this embodiment of this application, since it is unnecessary to reserve a narrow pressing edge on the circuit board, a larger layout space is provided for a portion of the circuit board away from the first notch, optimizing the layout of electronic components on the circuit board and facilitating the thin and light design of the entire electronic device.

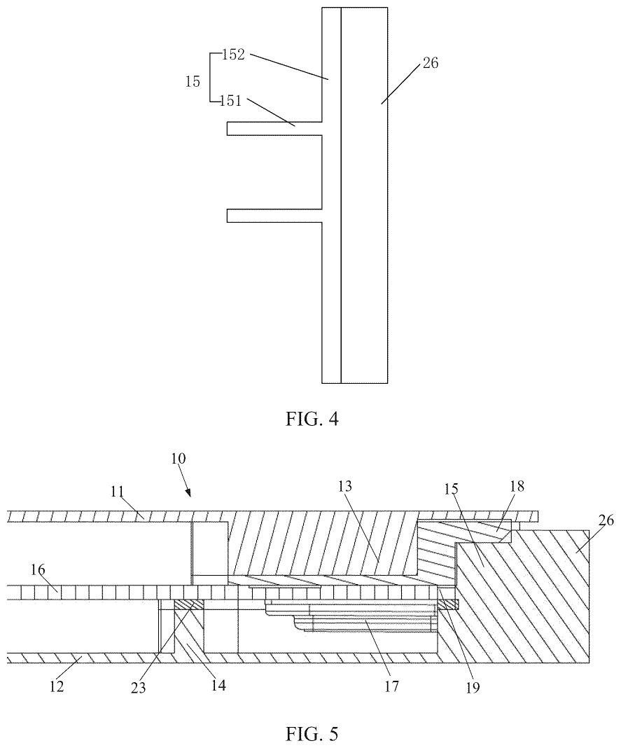

Optionally, FIG. 4 is a possible schematic structural diagram of the transition leg 15. As shown in FIG. 4, the transition leg 15 includes two extension portions 151 arranged opposite each other, and an upright plate 152 arranged between the two extension portions 151 and perpendicular to the two extension portions 151. A side portion of the transition leg 15 is formed by the two extension portions 151. The transition leg including the upright plate 152 can ensure that the first bracket, the second bracket, the circuit board, and the enclosing assembly can enclose a sealed chamber (that is, the acoustic chamber).

Optionally, the side portion of the transition leg extends into the first notch 161 and is hermetically connected to the circuit board 16.

It can be understood that in this embodiment of this application, the side portion of the transition leg is hermetically connected to a side wall of the circuit board corresponding to the first notch.

In this embodiment of this application, since the side portion of the transition leg extends into the first notch and is hermetically connected to the circuit board, a contact area between the transition leg and the circuit board can be increased, thereby improving the sealing reliability.

In the electronic device provided in this embodiment of this application, the circuit board is provided with the first notch, and the loudspeaker unit is arranged in the first notch, so that the loudspeaker unit is close to the edge of the circuit board, thereby shortening the sound outlet channel of the loudspeaker unit. This can improve the electroacoustic performance of the loudspeaker unit in the electronic device.

Optionally, the electronic device may further include a frame. The first bracket, the second bracket, the circuit board, the loudspeaker unit, and the enclosing assembly are arranged in the frame. As shown in FIG. 1, the transition leg 15 is arranged on the side wall 26 of the frame, and the acoustic chamber is enclosed by the first bracket 11, the second bracket 12, the circuit board 13, the enclosing assembly 25, and the side wall 26 of the frame.

Optionally, when the transition leg is arranged on the side wall of the frame, the transition leg may include only two extension portions arranged opposite each other, and the two extension portions are directly arranged on the side wall of the frame. In this way, the first bracket, the second bracket, the circuit board, the enclosing assembly, and the side wall of the frame enclose the acoustic chamber of the loudspeaker unit. Therefore, there is no need to arrange the upright plate, ensuring that the loudspeaker unit can be arranged as close to the frame as possible, thereby shortening the size of the sound outlet channel of the loudspeaker unit.

Optionally, a surface of the side wall of the frame close to the enclosing assembly may be subjected to a recessing treatment to facilitate a hermetical connection between the recessed portion and the first bracket.

Optionally, the transition leg and the frame may be integrally formed. Alternatively, the transition leg, the second enclosing plate, and the frame may be integrally formed.

In this embodiment of this application, the acoustic chamber is enclosed by the first bracket, the second bracket, the circuit board, the enclosing assembly, and the side wall of the frame, ensuring that the loudspeaker unit can be in direct contact with the side wall of the frame, thereby minimizing the size of the sound outlet channel of the loudspeaker unit.

Optionally, as shown in FIG. 2, the sound outlet hole 24 of the loudspeaker unit is arranged on the side wall 26 of the frame, and the sound outlet hole 24 is parallel to the circuit board 16.

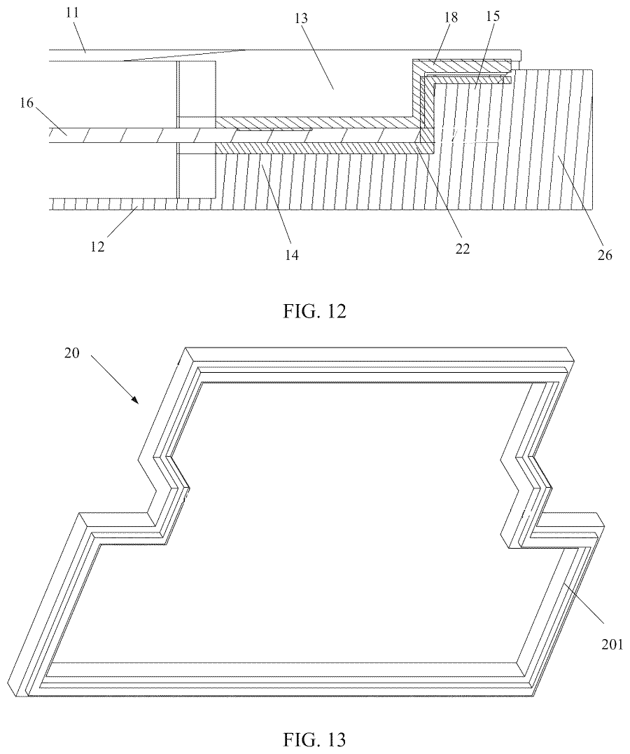

Optionally, as shown in FIG. 1, FIG. 5, FIG. 6 to FIG. 9, FIG. 11, and FIG. 12, the electronic device 10 may further include a first sealing structure 18, where the first sealing structure 18 is stepped. The first sealing structure 18 may include a first sub-sealing ring, a second sub-sealing ring, and two first climbing arms. The first sub-sealing ring and the second sub-sealing ring have opposite openings, and two ends of each of the first climbing arms are respectively connected to the first sub-sealing ring and the second sub-sealing ring.

The first sub-sealing ring is arranged between one end of the transition leg 15 and the first bracket 11; the two first climbing arms are arranged between the side portion of the transition leg 15 and the first enclosing plate 13; and the second sub-sealing ring is arranged between the first enclosing plate 13 and the circuit board 16.

It can be understood that in this embodiment of this application, the two first climbing arms do not intersect, so that the first sub-sealing ring, the second sub-sealing ring, and the two first climbing arms form a stepped sealing ring.

In this embodiment of this application, “the two first climbing arms are arranged between the side portion of the transition leg and the first enclosing plate” can be understood as that the two first climbing arms are arranged between the side portion of the transition leg and an outer wall at the side opening of the first enclosing plate.

In this embodiment of this application, the first climbing arm is perpendicular to the first sub-sealing ring and the second sub-sealing ring.

It can be understood that in this embodiment of this application, the size of the second sub-sealing ring matches the size of the projection region of the first enclosing plate on the circuit board.

Optionally, the first sealing structure may be made of sealing foam or silicone.

Optionally, as shown in FIG. 13, a surface of the first sealing structure 18 facing away from the first bracket 11 is provided with a sealing rib 201. This can prevent eccentric errors generated during assembly of the first sealing structure and the second sealing structure, thereby improving the sealing performance for the acoustic chamber in the electronic device.

In this embodiment of this application, since the first sealing structure is stepped, sealing between the first enclosing plate and the transition leg as well as sealing between the transition leg and the first bracket can be simultaneously implemented by using one sealing structure, thereby reducing sealing errors and improving the sealing performance.

Optionally, as shown in FIG. 1 and FIG. 5 to FIG. 9, the electronic device 10 may further include a target sealing ring 23 matching the projection region of the second enclosing plate 14 on the circuit board 16. The target sealing ring 23 is arranged between a top surface of the second enclosing plate 14 and a bottom surface of the circuit board 16, achieving sealing between the second enclosing plate 14 and the circuit board 16.

It can be seen that the target sealing ring has an opening, and the opening matches the side opening of the second enclosing plate. Optionally, the orientation and size of the opening of the target sealing ring are the same as those of the side opening of the second enclosing plate.

Optionally, the target sealing ring may be made of sealing foam or silicone.

Optionally, as shown in FIG. 5, when the first sealing structure 18 is used, a first gap 19 may be present between the circuit board 16 and the transition leg 15. In this embodiment of this application, two possible implementation methods (which are, one possible implementation method and another possible implementation method described below) may be used to seal the first gap.

In a possible implementation method, the electronic device may further include a second sealing structure. The second sealing structure seals the first gap between the circuit board and the transition leg.

The second sealing structure is described in detail below.

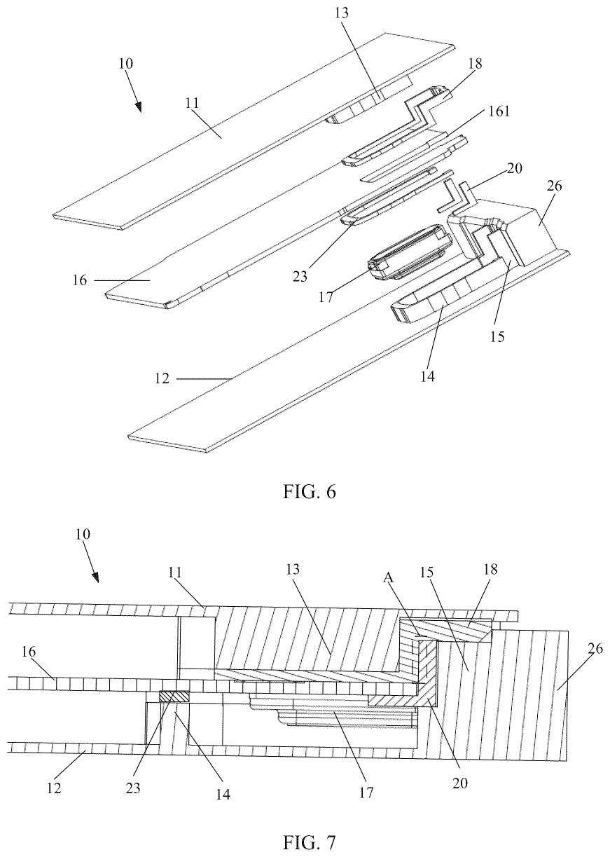

Optionally, in method 1, as shown in FIG. 6 and FIG. 7, the second sealing structure 20 may include a first support arm and a second support arm intersecting with each other. The first support arm is arranged on a surface of the circuit board 16 facing the second enclosing plate 14, and the second support arm is arranged between the circuit board 16 and the side portion of the transition leg 15 as well as between the first climbing arm and the side portion of the transition leg 15, so as to seal the first gap 19. In this way, the second sealing structure can not only seal the first gap between the circuit board and the transition leg but also improve sealing reliability because the first support arm is attached to the surface of the circuit board facing the second enclosing plate.

Optionally, the first support arm and the second support arm are connected, and the first support arm and the second support arm form an included angle, for example, 90°.

It can be seen that the first support arm and the second support arm are L-shaped. It can be understood that the second sealing structure with the first support arm and the second support arm may also be referred to as an L-shaped sealing bracket.

It can be understood that in this embodiment of this application, a portion of the second support arm is located between the circuit board and the side portion of the transition leg, and another portion of the second support arm is located between the first climbing arm and the transition leg.

Optionally, the first support arm may be arranged between the target sealing ring and the circuit board.

Optionally, the second support arm is in interference fit with the first climbing arm. This can avoid the presence of a gap between the first sealing structure and the second sealing structure, thereby increasing the sealing performance for the acoustic chamber.

In this embodiment of this application, the first support arm can be attached to the bottom surface of the circuit board, and the first support arm fills the first gap between the circuit board and the side portion of the transition leg. Therefore, the circuit board and the side portion of the transition leg can be sealed, and the connection strength of the second sealing structure can be enhanced, improving the sealing reliability.

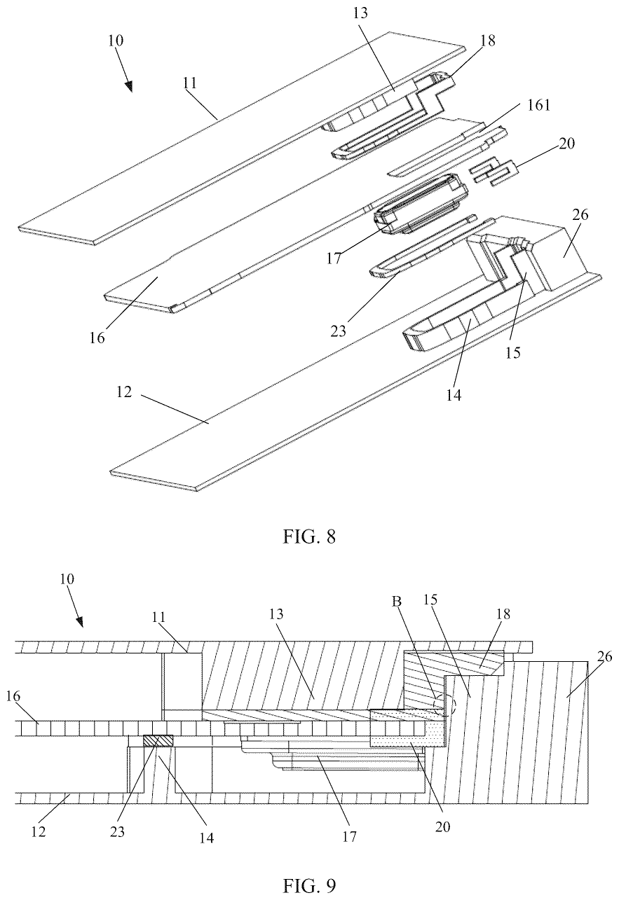

Optionally, in method 2, as shown in FIG. 8 and FIG. 9, the second sealing structure 20 may include a third support arm and a fourth support arm arranged opposite each other, and a connecting arm arranged between the third support arm and the fourth support arm.

The third support arm and the fourth support arm are respectively arranged on opposite surfaces of the circuit board 16, and the connecting arm is arranged between the circuit board 16 and the transition leg 15.

Optionally, it is assumed that the third support arm is arranged on the surface of the circuit board facing the first enclosing plate, the second support arm is arranged on the surface of the circuit board facing the second enclosing plate, and the connecting arm is arranged in the first gap (that is, the connecting arm fills the first gap).

It can be seen that the second sealing structure is clamped on the circuit board.

It can be understood that in this embodiment of this application, the third support arm may be arranged between the second sub-sealing ring and the circuit board, and is in interference fit with the second sub-sealing ring; and the fourth support arm may be arranged between the circuit board and the second enclosing plate, and is in interference fit with the target sealing ring.

In this embodiment of this application, the third support arm and the fourth support arm of the second sealing structure are respectively attached to the two opposite surfaces of the circuit board, and the connecting arm of the second sealing structure fills the first gap between the circuit board and the transition leg. Therefore, the sealing reliability between the circuit board and the transition leg can be improved.

In this embodiment of this application, two second sealing structures are provided in both the above method 1 and method 2, and the two second sealing structures are arranged corresponding to two sides of the first notch, for example, the two second sealing structures are both arranged in a region of the circuit board adjacent to the first notch.

In the above method 1 and method 2, a gap may be present between the first sealing structure and the second sealing structure.

For example, as shown in FIG. 7, when the second sealing structure 20 includes a first support arm and a second support arm intersecting with each other, a gap may be present in a corner between the first sealing structure 18 and the second sealing structure 20, that is, between the second support arm and the first climbing arm, and for example, in a region indicated by dashed box A in FIG. 7.

For another example, as shown in FIG. 9, when the second sealing structure 20 includes a third support arm, a fourth support arm, and a connecting arm, a gap may be in a corner between the first sealing structure 18 and the second sealing structure 20, that is, between the third support arm and the first climbing arm, and for example, in a region indicated by dashed box B in FIG. 9.

To seal the gap between the first sealing structure and the second sealing structure, the electronic device provided in this embodiment of this application may further include a first adhesive member. The first adhesive member fills the gap between the first sealing structure and the second sealing structure.

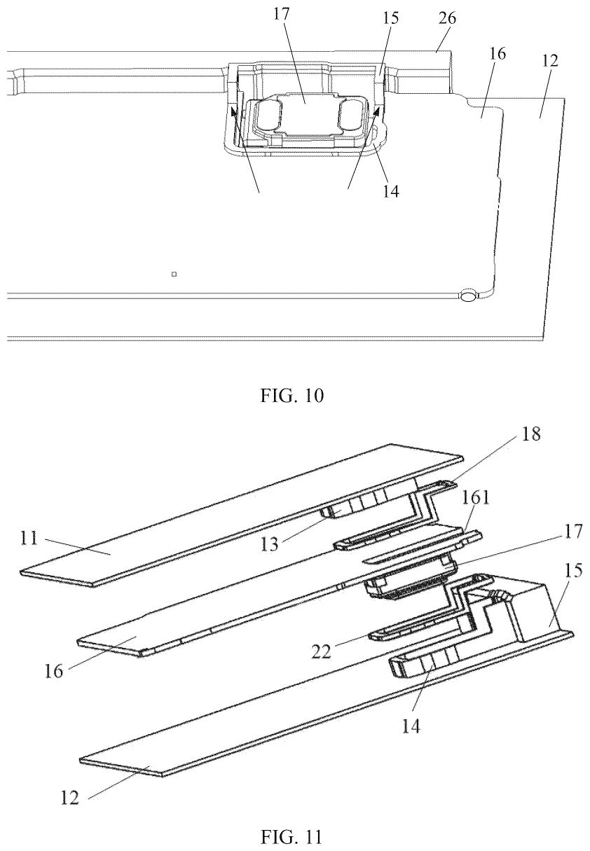

For example, as shown in FIG. 10, glue may be dispensed on a region indicated by an arrow in FIG. 10 between the first sealing structure 18 and the second sealing structure 20.

Optionally, the first adhesive member may be glue. To be specific, glue can be dispensed in the gap between the first sealing structure and the second sealing structure, so as to seal the gap between the first sealing structure and the second sealing structure.

In this embodiment of this application, since the gap between the first sealing structure and the second sealing structure can be sealed by a first adhesive member, the sealing performance for the acoustic chamber of the loudspeaker can be further improved.

Optionally, in method 3, the second sealing structure 20 may include a second adhesive member, where the second adhesive member fills the first gap 19 between the circuit board 16 and the transition leg 15 as shown in FIG. 5.

Optionally, the second adhesive member may be glue. To be specific, glue can be directly dispensed in the gap between the circuit board and the transition leg, so as to seal the circuit board and the transition leg.

In this embodiment of this application, since the gap between the circuit board and the transition leg can be adhered by the first adhesive member, the sealing performance for the acoustic chamber in the electronic device can be improved, and the assembly difficulty of the electronic device can be reduced.

In another possible implementation method, as shown in FIG. 12, the electronic device 10 may further include a third sealing structure 22, where the third sealing structure 22 is stepped. The third sealing structure 22 may include a third sub-sealing ring, a fourth sub-sealing ring, and two second climbing arms arranged between the third sub-sealing ring and the fourth sub-sealing ring.

The third sub-sealing ring and the fourth sub-sealing ring have opposite openings, and two ends of each of the second climbing arms are respectively connected to the third sub-sealing ring and the fourth sub-sealing ring.

The third sub-sealing ring is arranged between one end of the transition leg 15 and the first sub-sealing ring, and the third sub-sealing ring is in interference fit with the first sub-sealing ring; the fourth sub-sealing ring is arranged between the second enclosing plate 14 and the circuit board 16; the two second climbing arms are arranged between the side portion of the transition leg 15 and the circuit board 16 as well as between the side portion of the transition leg 15 and the first climbing arm; and the second climbing arm is in interference fit with the first climbing arm.

It can be understood that in this embodiment of this application, the fourth sub-sealing ring is equivalent to the target sealing ring in the above embodiment. To be specific, in another possible implementation method, two second climbing arms are respectively arranged at an opening of the fourth sub-sealing ring, and the two second climbing arms are connected to the third sub-sealing ring to form the third sealing structure.

Optionally, a surface of the third sealing structure facing the first bracket may be provided with a sealing rib. This can prevent eccentric errors generated during assembly of the first sealing structure and the second sealing structure, thereby improving the sealing performance for the acoustic chamber in the electronic device.

It can be understood that the sealing ribs on the third sealing structure and the first sealing structure can be staggered to facilitate the engagement of the first sealing structure and the third sealing structure through their respective sealing ribs.

For other descriptions of the third sealing structure, refer to the relevant descriptions in the foregoing embodiments.

In this embodiment of this application, the third sealing structure can seal the first gap between the circuit board and the side portion of the transition leg while sealing the second enclosing plate and the circuit board. Therefore, another possible implementation method can reduce the number of the sealing structures, thereby avoiding the introduction of new installation errors (for example, a gap between the first sealing structure and the second sealing structure).

The following illustratively describes the electronic device provided in this embodiment of this application.

In one possible implementation method, as shown in FIG. 6 and FIG. 7, the loudspeaker unit 17 is moved up to get close to a side of the frame (that is, a side wall), a narrow pressing edge at a corresponding position of the PCB (that is, the circuit board 16) is removed, and the side wall 26 of the frame serves as the transition leg 15 to extend into the notch of the PCB. The first sealing structure 18 is made of a silicone material, the first sub-sealing ring in the first sealing structure 18 is in pressing fit with the transition leg 15, and the second sub-sealing ring is in pressing fit with the PCB. L-shaped silicone (that is, the second sealing structure 20) is adhered to a step position between the transition leg 15 and the PCB, one side of the L-shaped silicone is adhered to the back of the PCB, and the other side is upward adhered along a side surface (that is, the side portion) of the transition leg 15 (actually, it can be upward adhered along the first climbing arm), filling the gap between the transition leg 15 and the PCB. Then, a corner between the first sealing structure 18 and the second sealing structure 20 is sealed by dispensing glue, thereby ensuring a good sealing effect.

In one possible implementation method, as shown in FIG. 8 and FIG. 9, the loudspeaker unit 17 is moved up to get close to a side of the frame (that is, a side wall), a narrow pressing edge at a corresponding position of the PCB (that is, the circuit board 16) is removed, and the side wall 26 of the frame serves as the transition leg 15 to extend into the notch of the PCB. The first sealing structure 18 is made of a silicone material, the first sub-sealing ring in the first sealing structure 18 is in pressing fit with the transition leg 15, and the second sub-sealing ring is in pressing fit with the PCB. A U-shaped silicone clip (that is, the second sealing structure 20) is adhered to a step position (that is, the first gap 19) between the first sealing structure 18 and the PCB, two long sides (that are, the third support arm and the fourth support arm) of the U-shaped silicone clip are respectively adhered to both sides of the PCB, and a side (that is, the connecting arm) of the U-shaped silicone clip is used for filling a gap at a step position between the transition leg 15 and the PCB. Then, a corner between the first sealing structure 18 and the U-shaped silicone clip is sealed by dispensing glue, thereby ensuring a good sealing effect for the acoustic chamber.

In one possible implementation method, as shown in FIG. 5, the loudspeaker unit 17 is moved up to get close to a side of the frame (that is, a side wall), a narrow pressing edge at a corresponding position of the PCB (that is, the circuit board 16) is removed, and the side wall 26 of the frame serves as the transition leg 15 to extend into the notch of the PCB. The first sealing structure 18 is made of a silicone material, the first sub-sealing ring in the first sealing structure 18 is in pressing fit with the transition leg 15, the second sub-sealing ring is in pressing fit with the PCB, and a step position (that is, the first gap 19) between the transition leg 15 and the PCB is sealed by dispensing glue. Since the narrow pressing edge on the PCB is removed, the loudspeaker unit 17 can move toward the frame, shortening the sound outlet channel and optimizing the PCB layout. In addition, due to the adaptability of a silicone gasket (that is, the first sealing structure 18) to glue sealing, the gap at the step position that is originally difficult to seal through interference fit can be filled with glue to ensure the airtightness of the entire upward chamber, while non-step positions are in interference fit with the silicon gasket to achieve a good sealing effect.

In another possible implementation method, as shown in FIG. 11 and FIG. 12, the loudspeaker unit 17 is moved up to get close to a side of the frame (that is, a side wall), a narrow pressing edge at a corresponding position of the PCB (that is, the circuit board 16) is removed, and the side wall 26 of the frame serves as the transition leg 15 to extend into the notch of the PCB. The first sealing structure 18 is made of a silicone material, the first sub-sealing ring in the first sealing structure 18 is pressed between the transition leg 15 and the first bracket 11, and the second sub-sealing ring is pressed between the PCB and the first enclosing plate 13.

The sealing foam (that is, the target sealing ring 23) between the second bracket and the second enclosing plate 14 is replaced with a stepped third sealing structure 22, where the lower half portion of the third sealing structure 22 (that is, the fourth sub-sealing ring) is laid between the second enclosing plate 14 and the PCB, and the upper half portion of the third sealing structure 22 (that is, the third sub-sealing ring) is laid at a step position of the transition leg 15. Optionally, the third sub-sealing ring is arranged between one end of the transition leg 15 and the first sub-sealing ring, and the third sub-sealing ring is in interference fit with the first sub-sealing ring.

A surface of the first sealing structure 18 facing away from the first bracket 11 is provided with a sealing rib 201. In this case, the step position between the transition leg 15 and the PCB is sealed through the interference fit between the first sealing structure 18 made of a silicone material and the third sealing structure 22 made of a sealing foam material. The first sealing structure 18 and the third sealing structure 22 are both soft structures, which can ensure the fitting and sealing at the step position and the corner of the transition leg 15. In addition, the sealing rib on the first sealing structure 18 can avoid poor sealing caused by eccentric errors generated during assembly of the first sealing structure 18 and the third sealing structure 22.

Optionally, the electronic device in this embodiment of this application may be a mobile electronic device or a non-mobile electronic device. For example, the mobile electronic device may be a mobile phone, a tablet computer, a notebook computer, a palmtop computer, a vehicle-mounted electronic device, a wearable device, an ultra-mobile personal computer (UMPC), a netbook, a personal digital assistant (PDA), or the like; and the non-mobile electronic device may be a personal computer (PC), a television (TV), a smart speaker, a teller machine, a self-service machine, or the like. This is not specifically limited in the embodiments of the present invention.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to executing the functions in an order shown or discussed, but may also include executing the functions in a substantially simultaneous manner or in a reverse order, depending on the functions involved. For example, the described methods may be performed in an order different from that described, and steps may alternatively be added, omitted, or combined. In addition, features described with reference to some examples may be combined in other examples.

Based on the above description of the embodiments, persons skilled in the art can clearly understand that the method in the foregoing embodiments can be implemented through software on a necessary hardware platform or certainly through hardware only, but in many cases, the former is the more preferred implementation. Based on such an understanding, the technical solutions of the present invention essentially or the part contributing to the prior art may be implemented in a form of a software product. The software product is stored in a non-transitory storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this disclosure.

The foregoing describes the embodiments of this application with reference to the accompanying drawings. However, this application is not limited to the foregoing embodiments. The foregoing embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. An electronic device, comprising: a first bracket and a second bracket arranged opposite each other, as well as a circuit board, a loudspeaker unit, and an enclosing assembly that are located between the first bracket and the second bracket; wherein
the circuit board has a first notch, and the loudspeaker unit is arranged in the first notch;
the enclosing assembly is arranged around the first notch, and the enclosing assembly is hermetically connected to the first bracket, the second bracket, and the circuit board; and
the first bracket, the second bracket, the circuit board, and the enclosing assembly enclose an acoustic chamber of the loudspeaker unit.

2. The electronic device according to claim 1, wherein the enclosing assembly comprises: a first enclosing plate, a second enclosing plate, and a transition leg; wherein the first enclosing plate is arranged between the first bracket and the circuit board, and two ends of the first enclosing plate are hermetically connected to the first bracket and the circuit board;
the second enclosing plate is arranged between the second bracket and the circuit board, and two ends of the second enclosing plate are hermetically connected to the second bracket and the circuit board;
the first enclosing plate and the second enclosing plate each have a side opening facing a same direction as the first notch; and
a side portion of the transition leg is hermetically connected to the side opening of the first enclosing plate, the side opening of the second enclosing plate, and the circuit board, and two ends of the transition leg are hermetically connected to the first bracket and the second bracket; wherein
the first notch is located at inner sides of projection regions of the first enclosing plate and the second enclosing plate on the circuit board.

3. The electronic device according to claim 2, wherein the side portion of the transition leg extends into the first notch and is hermetically connected to the circuit board.

4. The electronic device according to claim 2, further comprising: a frame; wherein
the first bracket, the second bracket, the circuit board, the loudspeaker unit, and the enclosing assembly are arranged in the frame; wherein
the transition leg is arranged on a side wall of the frame, and the acoustic chamber is enclosed by the first bracket, the second bracket, the circuit board, the enclosing assembly, and the side wall of the frame.

5. The electronic device according to claim 2, further comprising: a first sealing structure, wherein the first sealing structure is stepped;
the first sealing structure comprises a first sub-sealing ring, a second sub-sealing ring, and two first climbing arms arranged between the first sub-sealing ring and the second sub-sealing ring; and
the first sub-sealing ring and the second sub-sealing ring have opposite openings, and two ends of each of the first climbing arms are respectively connected to the first sub-sealing ring and the second sub-sealing ring; wherein
the first sub-sealing ring is arranged between one end of the transition leg and the first bracket, the two first climbing arms are arranged between the side portion of the transition leg and the first enclosing plate, and the second sub-sealing ring is arranged between the first enclosing plate and the circuit board.

6. The electronic device according to claim 5, wherein a surface of the first sealing structure facing away from the first bracket is provided with a sealing rib.

7. The electronic device according to claim 5, further comprising:
a second sealing structure, sealing a first gap between the side portion of the transition leg and the circuit board.

8. The electronic device according to claim 7, wherein the second sealing structure comprises: a first support arm and a second support arm intersecting with each other; wherein
the first support arm is arranged on a surface of the circuit board facing the second enclosing plate, and the second support arm is arranged between the side portion of the transition leg and the circuit board as well as between the side portion of the transition leg and the first climbing arm, so as to seal the first gap.

9. The electronic device according to claim 7, wherein the second sealing structure comprises: a third support arm and a fourth support arm arranged opposite each other, and a connecting arm arranged between the third support arm and the fourth support arm; wherein
the third support arm and the fourth support arm are respectively arranged on opposite surfaces of the circuit board, and the connecting arm is arranged in the first gap.

10. The electronic device according to claim 7, further comprising:
a first adhesive member, filling a gap between the first sealing structure and the second sealing structure.

11. The electronic device according to claim 6, wherein the second sealing structure comprises: a second adhesive member filling the first gap.

12. The electronic device according to claim 5, further comprising: a third sealing structure; wherein the third sealing structure is stepped;
the third sealing structure comprises a third sub-sealing ring, a fourth sub-sealing ring, and two second climbing arms arranged between the third sub-sealing ring and the fourth sub-sealing ring; and
the third sub-sealing ring and the fourth sub-sealing ring have opposite openings, and two ends of each of the second climbing arms are respectively connected to the third sub-sealing ring and the fourth sub-sealing ring; wherein
the third sub-sealing ring is arranged between one end of the transition leg and the first sub-sealing ring, the third sub-sealing ring is in interference fit with the first sub-sealing ring, the fourth sub-sealing ring is arranged between the second enclosing plate and the circuit board, the two second climbing arms are arranged between the side portion of the transition leg and the circuit board as well as between the side portion of the transition leg and the first climbing arm, and the second climbing arm is in interference fit with the first climbing arm.

13. The electronic device according to claim 1, wherein the loudspeaker unit is arranged on the second bracket.
